(19) United States
(12) Patent Application Publication
(10) Pub. No.: US 2026/0365236 A1
(43) Pub. Date: Nov. 19, 2026

(54) VEHICLE CONTROL SYSTEM AND METHOD

(71) Applicants: HYUNDAI MOTOR COMPANY, Seoul (KR); KIA CORPORATION, Seoul (KR)

(72) Inventor: Jae Yong Park, Hwaseong-si (KR)

(73) Assignees: HYUNDAI MOTOR COMPANY, Seoul (KR); KIA CORPORATION, Seoul (KR)

(21) Appl. No.: 19/329,053

(22) Filed: Sep. 15, 2025

(30) Foreign Application Priority Data
May 14, 2025 (KR) 10-2025-0062406

(51) Int. Cl. B62D 6/00; B60W 10/20; B60W 30/045; B60W 30/18; B62D 15/02

(52) U.S. Cl. CPC B62D 6/002; B60W 10/20; B60W 30/045; B60W 30/18145; B62D 15/021; B60W 2510/205; B60W 2510/207; B60W 2520/105; B60W 2520/14; B60W 2540/18

(57) ABSTRACT

A vehicle control system includes a steering unit configured to control a direction of a vehicle, a sensor unit configured to detect driving data of the vehicle, a rear-wheel control device configured to control each of a plurality of rear wheels independently, and a control unit electrically connected to the steering unit, the sensor unit, and the rear-wheel control device and configured to control, based on a detection value of the sensor unit, an angle of each rear wheel independently of a front wheel of the vehicle by the rear-wheel control device.

### CROSS-REFERENCE TO RELATED APPLICATION

This application claims benefit of and priority to Korean Patent Application No. 10-2025-0062406 under 35 U.S.C. § 119, filed on May 14, 2025 in the Korean Intellectual Property Office, the disclosure of which is incorporated herein by reference in its entirety.

### FIELD

The present disclosure relates to a vehicle control system and a vehicle control method using the vehicle control system.

### BACKGROUND

A vehicle control system may affect cornering (turning) performance of a vehicle. In general, a front-wheel drive (FWD) vehicle and a rear-wheel drive (RWD) vehicle may exhibit different behaviors during turning, due to differences in positions of the driving wheels.

A FWD vehicle may generate driving force by transmitting power generated by an engine to a front wheel, and may have a structure in which the engine and a transmission are arranged at the front of the vehicle.

Conversely, an RWD vehicle may generate driving force by transmitting power generated by an engine to a rear wheel. An RWD system may provide high stability at high speeds. However, on slippery surfaces such as snowy roads, grip force of the rear wheel may become weak, making steering difficult.

The above information disclosed in this Background section is only for understanding of the background of the disclosure, and, therefore, it may contain information that does not constitute prior art.

### SUMMARY

An aspect of the present disclosure is to provide a vehicle control system a structure capable of alleviating understeering occurring during engine braking, and a vehicle control method using the same.

Another aspect of the present disclosure is to provide a vehicle control system having a structure capable of increasing straight-line stability by controlling a rear wheel during vehicle deceleration, and a vehicle control method using the same.

Another aspect of the present disclosure is to provide a vehicle control system having a structure capable of increasing vehicle turning performance by controlling a rear wheel, and a vehicle control method using the same.

According to an aspect of the present disclosure, a vehicle control system includes a steering unit configured to control a direction of a vehicle, a sensor unit configured to detect driving data of the vehicle, a rear-wheel control device configured to control each of a plurality of rear wheels independently, and a control unit electrically connected to the steering unit, the sensor unit and the rear-wheel control device and configured to control, based on a detection value of the sensor unit, an angle of each rear wheel independently of a front wheel of the vehicle by the rear-wheel control device.

The sensor unit may include an acceleration sensor configured to detect an acceleration of the vehicle, and a steering sensor configured to detect a steering angle and a steering speed of the front wheel of the vehicle.

The control unit may be configured to control the rear-wheel control device, based on deceleration of the vehicle detected by the acceleration sensor and the steering angle and the steering speed of the front wheel of the vehicle detected by the steering sensor, such that the rear wheel is toed-in.

The angle may include a toe-in angle of the rear wheel. The toe-in angle may be in a range of about 0 degrees to about 2 degrees.

The control unit may be configured to control the rear-wheel control device such that the rear wheel of the vehicle is toed-in. The control unit may be configured to determine, based on a yaw rate change rate of the vehicle measured by the sensor unit, straight-line braking stability of the vehicle.

The driving data of the vehicle may include a speed, a steering angle, a steering speed, and an understeer gradient of the vehicle.

The control unit may be configured to determine whether understeering occurs by comparing a reference yaw rate, based on the driving data of the vehicle, with a yaw rate of the vehicle obtained from the sensor unit.

The control unit may be configured to determine whether understeering occurs in the vehicle, based on the driving data of the vehicle. The control unit may be configured to determine whether an additional yaw moment is necessary for the vehicle, based on an understeer gradient and an additional steering angle obtained by the sensor unit, and to control the rear wheel through the rear-wheel control device.

The control unit may be configured to control the rear-wheel control device such that the rear wheel performs reverse-phase steering relative to the front wheel of the vehicle.

According to another aspect of the present disclosure, a vehicle control method includes determining, by a control unit, whether a vehicle approaches to a turning course, controlling, by the control unit, a rear wheel based on deceleration of the vehicle, and determining, by the control unit, whether the vehicle changes a gear. Controlling the rear wheel may include controlling an angle of the rear wheel, based on a deceleration and a steering angle and a steering speed of the vehicle detected by the sensor unit.

Controlling the rear wheel may include controlling toe of the rear wheel in case that the deceleration measured by the sensor unit is greater than or equal to a reference deceleration and the steering angle and the steering speed is less than or equal to a reference steering angle.

The vehicle control method may further include storing, in the control unit, data on the reference deceleration and the reference steering angle.

The control unit may be configured to control the rear-wheel control device such that the rear wheel is toed-in. An angle at which the rear wheel is toed-in may be in a range of about 0 degrees to about 2 degrees.

The vehicle control method may further include determining, by the control unit, whether the vehicle enters a turning course, controlling, by the control unit, the rear wheel such that the vehicle performs tuck-in, and determining, by the control unit, whether the vehicle exits the turning course. Controlling the rear wheel may include controlling the rear wheel using an understeer gradient and an additional steering angle.

Controlling the rear wheel may include controlling, by the control unit, the rear wheel to perform reverse-phase steering relative to the front wheel, in case that the understeer gradient is greater than or equal to a reference understeer gradient and the additional steering angle is greater than or equal to a reference additional steering angle.

According to another aspect of the present disclosure, a vehicle control method includes determining, by a control unit, whether a vehicle is approaching a turning course, controlling, by the control unit, a rear wheel in case that the vehicle decelerates, determining, by the control unit, whether the vehicle changes a gear, detecting, by the control unit, that the vehicle is entering the turning course, controlling, by the control unit, the rear wheel based on deceleration of the vehicle such that the vehicle performs tuck-in, and determining, by the control unit, whether the vehicle exits the turning course. Controlling the rear wheel may include controlling a rear-wheel control device such that the rear wheel is toed-in based on a steering angle of the vehicle.

In case that the vehicle decelerates, the control unit may be configured to control the rear-wheel control device such that the rear wheel are toed-in in case that the steering angle of the vehicle is less than or equal to a reference steering angle. A toe-in angle of the rear wheel may be in the range of about 0 degrees to about 2 degrees.

Controlling the rear wheel such that the vehicle performs tuck-in may include determining, by the control unit, whether understeering occurs in the vehicle, determining, by the control unit, whether the vehicle decelerates in a lift-off manner, and controlling, by the control unit, the rear-wheel control device such that the rear wheel performs reverse-phase steering relative to the front wheel.

Controlling the rear-wheel control device such that the rear wheel performs reverse-phase steering relative to the front wheel may be performed in case that an understeer gradient of the vehicle is greater than or equal to a reference understeer gradient, and an additional steering angle of the vehicle is greater than or equal to a reference additional steering angle.

The rear-wheel control device may include a first rear-wheel control device and a second rear-wheel control device. The first rear-wheel control device and the second rear-wheel control device may independently control a left rear wheel and a right rear wheel, respectively.

According to embodiments of the present disclosure, understeering occurring during engine braking may be alleviated.

According to embodiments of the present disclosure, straight-line stability may be increased by controlling a rear wheel during vehicle deceleration.

According to embodiments of the present disclosure, vehicle turning performance may be increased by controlling a rear wheel.

It is to be understood that both the foregoing general description and the following detailed description are exemplary and explanatory and are intended to provide further explanation of the disclosure as claimed.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic block diagram illustrating a vehicle control system according to an embodiment;

FIG. 2 is a schematic example diagram illustrating information on specifications of a vehicle;

FIG. 3 is a schematic flowchart illustrating a vehicle control method according to an embodiment;

FIG. 4 is a schematic diagram illustrating a vehicle control method according to a location of a turning course.

FIG. 5 is a schematic flowchart illustrating a portion of the vehicle control method according to an embodiment;

FIG. 6 is a schematic graph illustrating lateral force applied to a vehicle according to a toe angle of a rear wheel during straight-line braking of a vehicle according to an embodiment; and

FIG. 7 is a schematic flowchart illustrating a portion of a vehicle control method according to an embodiment.

### DETAILED DESCRIPTION

Various modifications may be made to the embodiments. Here, the embodiments are not construed as limited to the disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “unit,” “portion,” “part,” and the like may be used to describe various components, but the components should not be limited by the terms. The above-described terms may refer to a term indicating not only a physically/visually distinct component, but also a function or component of a corresponding portion even in case that not clearly divided or partitioned. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

In the description below, the terms used in relation to direction, such as “front,” “rear,” “side,” “forward,” “rearward,” “vertical,” “lateral,” “above,” “upper,” “upper portion” “below,” “lower,” “lower portion,” and the like, are defined based on a vehicle VH or a body of the vehicle. In addition, the terms such as first, second, A, B, (a), (b), and the like may be used herein to describe components. Each of these terminologies is not used to define an essence, order or sequence of a corresponding component but used merely to distinguish the corresponding component from other component(s).

Hereinafter, embodiments of the present disclosure are described in more detail with reference to the accompanying drawings.

In the drawings, D1 may be referred to as a first direction (D1), and D2, intersecting the first direction (D1), may be referred to as a second direction (D2). D3, intersecting each of the first direction (D1) and the second direction (D2), may be referred to as a third direction (D3). The third direction (D3) may be referred to as an upward direction, and an opposite direction to the third direction (D3) may be referred to as a downward direction. In addition, each of the first direction (D1) and the second direction (D2) may be referred to as a horizontal direction. The first direction (D1) may be referred to as an axial direction.

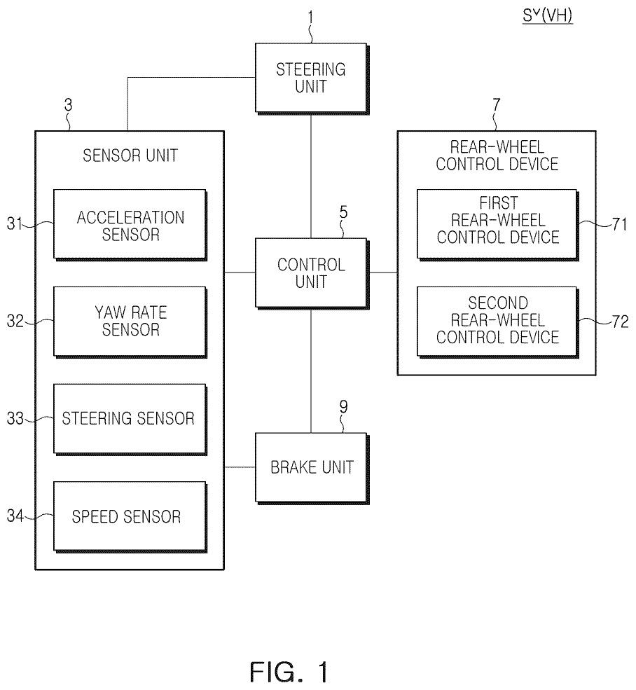

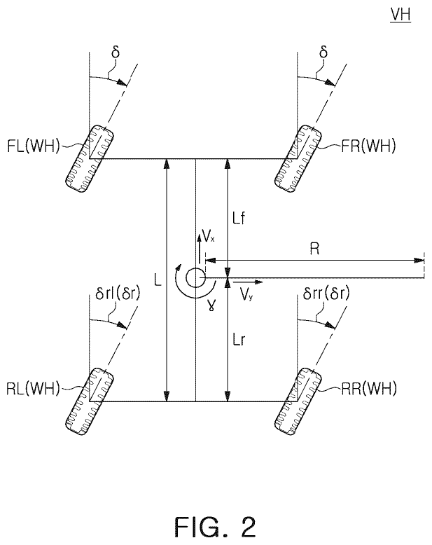

FIG. 1 is a schematic block diagram illustrating a vehicle control system SY according to an embodiment. FIG. 2 is a schematic example diagram illustrating information on specifications of a vehicle VH.

The vehicle VH may include a vehicle control system SY. The vehicle control system SY may control not only a direction of the vehicle VH but also an angle of a wheel WH. As used herein, the wheel WH may include front wheels FR (i.e., front-right) and FL (i.e., front-left) and rear wheels RR (i.e., rear-right) and RL (i.e., rear-left). Hereinafter, the front wheels may be referred to as front wheels, and the rear wheels may be referred to as rear wheels.

As used herein, the vehicle VH may refer to a rear-wheel drive (RWD) vehicle. A front-wheel drive vehicle (FWD) may have a characteristic in which tuck-in easily occurs. Tuck-in may refer to a phenomenon in which, during cornering of the vehicle VH, in case that a driver releases a throttle or slightly presses a brake, a load may be concentrated on the front wheels FR and FL of the vehicle VH, thereby making a steering response more sensitive. For example, the front wheels FR and FL may be responsible for both steering and driving force, such that an increase in the grip force of the front wheels FR and FL may occur during deceleration. Thus, the FWD vehicle may exhibit an effect in which the vehicle VH more sharply enters into the inside of a corner. Such an effect may be advantageous particularly in a winding road or in circuit driving that requires rapid turning.

Conversely, tuck-in may not easily occur in the RWD vehicle. The RWD vehicle may have driving force concentrated on the rear wheels RR and RL, as compared to the FWD vehicle. Thus, during deceleration, an amount of decrease in the grip force of the rear wheels RR and RL of the RWD vehicle due to forward transfer of a load of the vehicle VH may be less than that of the FWD vehicle. Accordingly, a steering response of the vehicle VH may become relatively dull. In particular, in case that the vehicle VH enters a corner, oversteer may not sufficiently occur due to toe-in, resulting in degradation in turning performance of the vehicle VH.

The vehicle control system SY according to an embodiment may improve straight-line braking stability and turning performance of the vehicle VH by controlling the rear wheels RR and RL, as will be described below.

Referring to FIGS. 1 and 2, the vehicle control system SY according to an embodiment may include a steering unit 1, a sensor unit 3, a control unit 5, and a rear-wheel control device 7. The vehicle control system SY according to an embodiment may selectively include a brake unit 9. Thus, in other embodiments, the vehicle control system SY may not include the brake unit 9.

The steering unit 1 may be electrically connected to the control unit 5 and sensor unit 3. The steering unit 1 may allow a direction of travel of the vehicle VH to be changed by transmitting a steering input of the driver to the wheel WH of the vehicle VH. The steering unit 1 according to an embodiment may include a steering wheel, a steering column, a steering gear, a knuckle, and a suspension link. However, it is an only example, a component included in the steering unit 1 is not limited thereto. In case that the driver operates the steering wheel, information on rotational force and rotation angle may be transmitted to the steering gear through the steering column. The steering gear may transmit the rotational force to the wheel WH of the vehicle VH through a tie rod. As a result, the vehicle VH may stably travel along a given path while turning left or right.

The steering unit 1 according to an embodiment may include an electric power steering (EPS) system or a hydraulic power steering (HPS) system. However, a component included in the steering unit 1 is not limited thereto.

The brake unit 9 may be electrically connected to the control unit 5 and the sensor unit 3 and may decelerate or stop the vehicle VH. The brake unit 9 according to an embodiment may include a brake pedal, a brake pipe, a caliper, a brake disc, and a brake pad. When the driver presses the brake pedal, a cylinder may pressurize brake oil to operate the brake caliper. In the case of a disc brake system, the caliper may press the brake pad against the disc to generate frictional force, thereby decelerating or stopping a speed of the vehicle.

The brake unit 9 according to an embodiment may include an electronic control device such as an anti-lock braking system (ABS), an electronic stability control (ESC), or an electronic brakeforce distribution (EBD). The ABS may prevent locking of the wheel WH during emergency braking of the vehicle VH, thereby maintaining steerability of the vehicle VH. The ESC, as an electronic driving stability device, may prevent understeer or oversteer from occurring in the vehicle VH during abrupt steering or on a slippery road. The EBD, as an electronic brakeforce distribution system, may optimize and distribute braking force of each wheel WH according to load distribution and a driving state of the vehicle VH. However, a component included in the brake unit 9 is not limited thereto, and may further include other components to improve braking performance of the vehicle VH.

The sensor unit 3 may be electrically connected to the steering unit 1, control unit 5 and brake unit 9 and may detect driving data of the vehicle VH. The sensor unit 3 may measure and sense various types of information of the vehicle VH. The sensor unit 3 according to an embodiment may include an acceleration sensor, a yaw rate sensor, a steering sensor, and a speed sensor. However, it is an only example, a sensor included in the sensor unit 3 is not limited thereto. The driving data of the vehicle VH according to an embodiment may include a speed, a steering angle, an acceleration, a yaw rate, and an understeer gradient of the vehicle VH.

The acceleration sensor 31 may measure a linear acceleration and deceleration of the vehicle VH and may sense a change in force during acceleration, deceleration, or turning of the vehicle VH. Hereinafter, as used herein, acceleration may be used to include deceleration. For example, in case that the vehicle VH has a positive (+) acceleration, a vehicle speed may increase. In case that the vehicle VH has a negative (−) acceleration, the vehicle VH may decelerate and the vehicle speed may decrease. Negative acceleration may have the same meaning as deceleration. The acceleration sensor according to an embodiment may detect micro-vibrations and displacement changes using a micro-electro-mechanical system (MEMS) method. Based thereon, the acceleration sensor 31 may measure lateral acceleration and longitudinal acceleration of the vehicle VH. In addition, the acceleration sensor 31 may improve safety of the vehicle VH in connection with collision detection of the vehicle VH, an ESC, and a vehicle dynamic control (VDC) system.

The yaw rate sensor 32 may measure an angular velocity (yaw rate) in case that the vehicle VH rotates to maintain driving stability. The yaw rate sensor 32 may measure a rotational speed of the vehicle VH per unit time about a vertical axis of the vehicle VH and may determine, based thereon, whether understeer or oversteer occurs. The yaw rate sensor 32 according to an embodiment may calculate the yaw rate by detecting Coriolis force generated in case that the vehicle VH rotates, using a gyroscope-based MEMS method. The yaw rate sensor 32 according to an embodiment may monitor a driving state of the vehicle VH in connection with the ESC. Furthermore, the yaw rate sensor 32 may assist the vehicle VH in traveling in an intended direction by controlling the brake unit 9 connected to an individual wheel WH in case that it is necessary. In addition, the yaw rate sensor 32 may be used in combination with an autonomous driving system and an active steering system to improve steering responsiveness of the vehicle VH and secure stability during high-speed driving.

The steering sensor 33 may measure a steering angle and a steering speed of a steering wheel operated by the driver and may determine a steer state of the vehicle VH. The steering sensor 33 may detect a rotation angle of the steering wheel using an optical sensor or a Hall effect sensor, and may assist steering force in connection with an EPS system. In addition, the steering sensor 33 may improve steering responsiveness of the vehicle VH in conjunction with the ESC and an active steering control system.

The speed sensor 34 may measure a traveling speed of the vehicle VH to allow a driving state of the vehicle VH to be determined. The speed sensor 34 may measure an actual traveling speed of the vehicle VH using a wheel speed sensor or a GPS-based speed sensor, and may perform functions such as an anti-lock brake system (ABS), an electronic brake force distribution system (EBD), and cruise control, based thereon. In addition, the speed sensor 34 may be used together with the acceleration sensor 31 and the yaw rate sensor 32 to analyze turning stability of the vehicle VH and control understeer and oversteer of the vehicle VH.

The rear-wheel control device 7 may be electrically connected to the control unit 5 and may control (or actively control) the rear wheels RR and RL of the vehicle VH. Thus, it may improve driving stability and steering performance of the vehicle VH. The vehicle VH to which the rear-wheel control device 7 is applied may enable steering of the rear wheels RR and RL as well, thereby securing both maneuverability in narrow spaces and stability during high-speed driving. The rear-wheel control device 7 may control not only steering of the rear wheels RR and RL, but also camber and toe of the rear wheels RR and RL. The rear-wheel control device 7 according to an embodiment may include a rear-wheel steering (RWS) device.

The rear-wheel control device 7 according to an embodiment may include a first rear-wheel control device 71 and a second rear-wheel control device 72. The first rear-wheel control device 71 and the second rear-wheel control device 72 may be electrically connected to different rear wheels RR and RL. For example, the first rear-wheel control device 71 may be electrically connected to a left rear wheel RL, and the second rear-wheel control device 72 may be electrically connected to a right rear wheel RR. Each of the first rear-wheel control device 71 and the second rear-wheel control device 72 may control the left rear wheel RL and the right rear wheel RR, independently and respectively. Hereinafter, the description of the rear-wheel control device 7 may be equally applied to the first rear-wheel control device 71 and the second rear-wheel control device 72. The first rear-wheel control device 71 and the second rear-wheel control device 72 may control the rear wheels RL and RR using an electric motor or a hydraulic system.

The control unit 5 may be electrically connected to the steering unit 1, the sensor unit 3, and the rear-wheel control device 7. The control unit 5 may be electrically connected to the brake unit 9. The control unit 5 may receive various types of information of the vehicle VH from the sensor unit 3. The control unit 5 may control the rear-wheel control device 7 based on the information obtained from the sensor unit 3. The control unit 5 may control a toe angle and a steering angle of each of the rear wheels RR and RL by controlling the rear-wheel control device 7. A detailed description thereof will be provided below.

The control unit 5 according to an embodiment may include at least one of a microprocessor, a microcontrol unit unit (MCU), a digital signal processor (DSP), a system on chip (SoC), an application processor, embedded memory, dynamic random access memory (DRAM), static random access memory (SRAM), electrically erasable programmable read-only memory (EEPROM), flash memory, ferroelectric random access memory (FRAM), magnetoresistive random access memory (MRAM), or non-volatile random access memory (NVRAM). However, types of electronic components included in the control unit 5 are not limited thereto.

Referring to FIG. 2, a schematic example diagram illustrating information on the specifications of a vehicle may be provided. L may refer to a wheelbase. L_{f} may refer to a distance from a center of gravity of the vehicle VH to a center of each of front wheels FR and FL. Lᵣ may refer to a distance from the center of gravity of the vehicle VH to a center of each of rear wheels RR and RL. δ may refer to a steering angle of each of the front wheels FR and FL. Or may refer to a toe angle of each of the rear wheels RR and RL. δᵣᵣ may refer to a toe angle of the right rear wheel RR. δᵣₗ may refer to a toe angle of the left rear wheel RL. R may refer to a turning radius of the vehicle. γ may refer to an angular velocity of the vehicle VH. Vₓ may refer to a longitudinal velocity of the vehicle VH. V_{y} may refer to a lateral velocity of the vehicle VH. The symbols are provided to aid in the understanding of the disclosure described below, and reference numerals may be partially omitted.

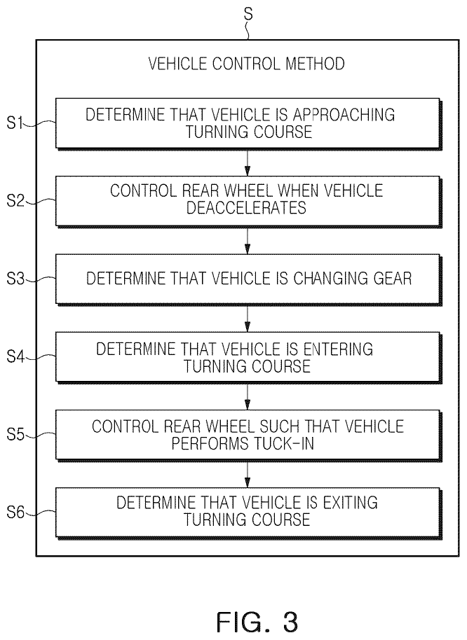

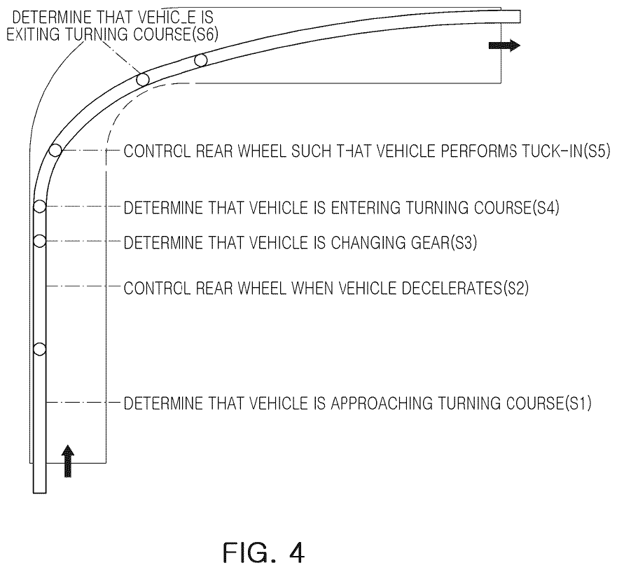

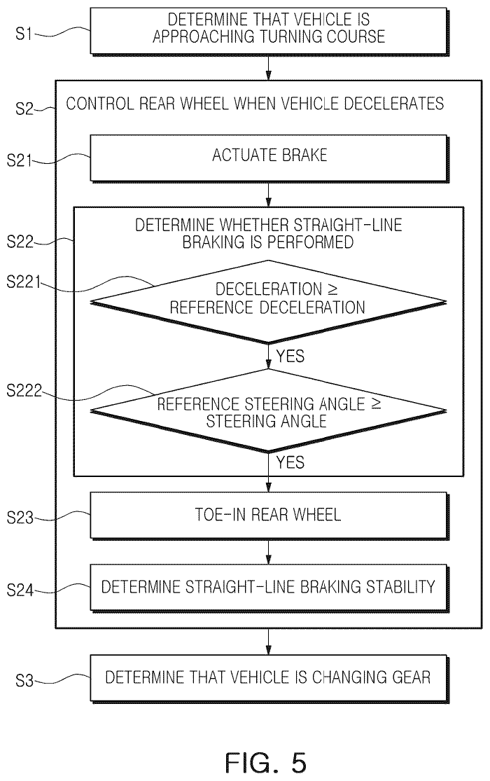

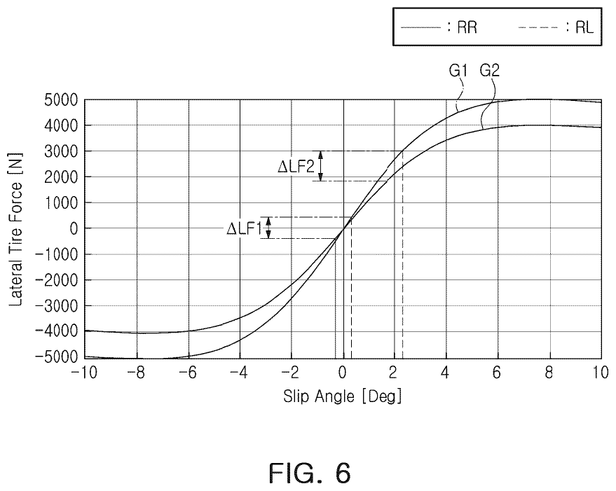

FIG. 3 is a schematic flowchart illustrating a vehicle control method S according to an embodiment, FIG. 4 is a schematic diagram illustrating the vehicle control method S according to a location of a turning course, FIG. 5 is a schematic flowchart illustrating a portion of the vehicle control method S according to an embodiment, and FIG. 6 is a schematic graph illustrating lateral force applied to the vehicle VH according to a toe angle (δᵣ) of each of the rear wheels RR and RL during straight-line braking of the vehicle VH.

Referring to FIGS. 3 and 4, the vehicle control method S according to an embodiment may include determining, by the control unit 5, whether the vehicle VH approaches to a turning course (S1), controlling, by the control unit 5, the rear wheels RR and RL in case that the vehicle VH decelerates (S2), and determining, by the control unit 5, whether the vehicle VH changes a gear (S3). The vehicle control method S may include determining, by the control unit 5, whether the vehicle VH enters the turning course (S4), controlling, by the control unit 5, the rear wheels RR and RL such that the vehicle VH performs tuck-in (S5), and determining, by the control unit 5, whether the vehicle VH exits the turning course (S6).

Referring to FIG. 3, in case that the vehicle VH approaches the turning course (S1), the vehicle may approach the turning course at a high speed (full throttle). For example, a throttle of the vehicle VH may be fully opened. The control unit 5 may determine whether the vehicle VH approaches the turning course by sensing a speed and a steering angle of the vehicle VH through the sensor unit 3. However, a method in which the control unit 5 determines whether the vehicle VH approaches the turning course is not limited thereto. For example, a GPS based sensor may be used to find out the location of the vehicle VH so that a signal is sent to the control unit 5 to determine whether the vehicle VH approaches the turning course. Hereinafter, in case that the vehicle VH travels, the control unit 5 may recognize the same as what a driver recognizes. The control unit 5 may operate to produce an effect the same as an effect resulting from an action of the driver.

As used herein, the turning course may be a right-turning course. An inner rear wheel positioned on the inside of the turning course may be a right rear wheel RR. An outer rear wheel positioned on the outside of the turning course may be a left rear wheel RL. Hereinafter, for ease of description, the inner rear wheel RR may be used to refer to the same meaning as the right rear wheel RR. The outer rear wheel RL may be used to refer to the same meaning as the left rear wheel RL. The first rear-wheel control device 71 may be positioned on the outside of the turning course. The second rear-wheel control device 72 may be positioned on the inside of the turning course.

Referring to FIGS. 3, 4, and 5, in an embodiment, the controlling, by the control unit 5, the rear wheels RR and RL in case that the vehicle VH decelerates (S2) may include (or be accomplished by) actuating, by the control unit 5, a brake (S21), determining, by the control unit 5, whether the vehicle VH performs straight-line braking (S22), and toeing in, by the control unit 5, the rear wheels RR and RL (S23). In an embodiment, the controlling, by the control unit 5, the rear wheels RR and RL in case that the vehicle VH decelerates (S2) may selectively include identifying, by the control unit 5, whether the vehicle VH performs straight-line braking (S24).

The control unit 5 may decelerate the vehicle VH by actuating the brake (S21) before the vehicle VH enters the turning course. The driver may apply strong braking by pressing a brake pedal. In case that the driver applies strong braking, the control unit 5 may determine whether the vehicle VH is performing straight-line braking (S22). In case that the vehicle VH is performing straight-line braking, the driver may not provide a steering input so as not to generate unnecessary lateral acceleration. The sensor unit 3 may detect a deceleration and a steering input value of the vehicle VH. The control unit 5 may determine whether straight-line braking is being performed, based on vehicle data obtained from the sensor unit.

In case that the control unit 5 determines whether straight-line braking is being performed (S22), an acceleration sensor 31 of the sensor unit 3 may measure a deceleration of the vehicle VH. The acceleration sensor 31 may transmit deceleration data of the vehicle VH to the control unit 5. The control unit 5 may compare the deceleration data with a reference deceleration stored in the control unit 5 (S221). The reference deceleration may be an arbitrary value stored in the control unit 5.

In case that the control unit 5 determines whether straight-line braking is being performed (S22), the yaw rate sensor 32 or the steering sensor 33 of the sensor unit 3 may detect a steering input value of the driver. The sensor unit 3 may detect a steering angle of the vehicle VH. The sensor unit 3 may transmit steering angle data of the vehicle VH to the control unit 5. The control unit 5 may compare the steering angle data obtained from the sensor unit 3 with a reference steering angle stored in the control unit 5 (S222). The reference steering angle may be an arbitrary value stored in the control unit 5.

In case that the deceleration of the vehicle VH is greater than or equal to the reference deceleration and the steering angle of the vehicle VH is less than or equal to the reference steering angle, the control unit 5 may determine that the vehicle is performing straight-line braking. For example, the deceleration of the vehicle VH may be in the range of about 0.9 G to about 1.0 G. More specifically, in case that the deceleration of the vehicle VH is about 0.9 G, which is greater than or equal to a reference deceleration of about 0.8 G, and the steering angle of the vehicle VH is about 1°, which is less than or equal to a reference steering angle of about 5°, the control unit 5 may determine that the vehicle VH is performing straight-line braking.

In case that the control unit 5 determines that the vehicle VH is performing straight-line braking, the control unit 5 may control the rear-wheel control device 7 such that the rear wheels RR and RL are toed-in (S23). The control unit 5 may control, based on the deceleration and the steering angle of the vehicle VH, the rear-wheel control device 7 such that the rear wheels RR and RL are toed-in. Toe may refer to an angle at which a front wheel or rear wheel of the vehicle VH is inclined inward or outward with respect to a central line of the vehicle VH. Toe-in may refer to a state in which a front portion of the wheel WH is inclined inward toward the central line of the vehicle VH. Toe-out may refer to a state in which the front portion of the wheel WH is spread outward from the vehicle VH. In case that the wheels WH are toe-in, straight-line braking performance of the vehicle VH may be improved.

Referring to FIG. 6, a graph may illustrate lateral force applied to each of the rear wheels RR and RL depending on a toe angle (δᵣ) of each of the rear wheels RR and RL during straight-line braking of the vehicle VH. A horizontal axis of the graph may refer to a slip angle of the wheel WH. A vertical axis of the graph may refer to lateral force of the wheel WH. The slip angle of the wheel WH may refer to a difference between a direction of extension from a central line of the wheel WH and a direction of actual movement of the wheel WH. The slip angle may occur in case that the wheel WH receives steering input and lateral force.

A first graph G1 of FIG. 6 may be a graph illustrating lateral force applied to an outer rear wheel depending on the slip angle of the wheel WH. A second graph G2 of FIG. 6 may be a graph illustrating lateral force applied to an inner rear wheel depending on the slip angle of the wheel WH. As described above, as used herein, in case that the vehicle VH turns right while travelling in a straight line, an inner rear wheel may be the right rear wheel RR, and the outer rear wheel may be the left rear wheel RL. In case that the vehicle VH is toed-in, a slip angle of the outer rear wheel RL may be greater than that of the inner rear wheel RR. In case that the vehicle VH is travelling in a straight line and accordingly the slip angle is 0°, a lateral force difference between the left rear wheel RL and the right rear wheel RR may correspond to of a first difference ΔLF1. In case that slip occurs during travelling of the vehicle VH in a straight line, the lateral force difference between the left rear wheel RL and the right rear wheel RR may increase. For example, in case that the slip angle is about 2°, the lateral force difference between the left rear wheel RL and the right rear wheel RR may correspond to a second difference ΔLF2. For example, the second difference ΔLF2 may be greater than the first difference ΔLF1. The lateral force difference between the left rear wheel RL and the right rear wheel RR may be proportional to a vertical force difference between the left rear wheel RL and the right rear wheel RR. The lateral force difference between the left rear wheel RL and the right rear wheel RR may act as a restoring force of the vehicle VH, and thus a yaw moment of the vehicle VH may be reduced in case that the lateral force difference occurs. The lateral force difference between the left rear wheel RL and the right rear wheel RR may act as a restoring force of the vehicle VH to prevent excessive slip of the vehicle VH. In case that the vehicle VH performs straight-line braking, the control unit 5 may control the rear-wheel control device 7 such that the rear wheels RR and RL are toed-in, thereby preventing a decrease in straight-line braking stability by means of restoring force, even in case that slip occurs. The toe angle (δᵣ) of each of the rear wheels RR and RL in a toe-in state according to an embodiment may be in the range of about 0° to about 2°. However, the toe angle (δᵣ) of each of the rear wheels RR and RL in a toe-in state is not limited thereto. Hereinafter, in case that the rear wheels RR and RL inward rotate in a state of alignment in a forward direction to be toed-in, the toe angle (δᵣ) may be referred to as a toe-in angle.

In case that the rear wheels RR and RL are toed-in by the control unit 5 and the rear-wheel control device 7, the control unit 5 may identify whether straight-line braking is being performed safely (S24). The control unit 5 may receive data on a yaw rate change rate from the yaw rate sensor 32 of the sensor unit 3. The control unit 5 may determine whether the straight-line braking of the vehicle VH is being performed safely by determining whether the yaw rate change rate is less than a reference yaw rate change rate. In case that the yaw rate change rate is less than the reference yaw rate change rate, the control unit 5 may determine that the vehicle VH may have high straight-line braking stability. In case that the yaw rate change rate is greater than the reference yaw rate change rate, the control unit 5 may determine that the vehicle VH may have low straight-line braking stability, and thus may change the toe angle (δᵣ) of each of the rear wheels RR and RL.

The driver may change a gear of the vehicle VH according to a decelerated speed of the vehicle VH. The control unit 5 may determine whether the vehicle VH change the gear (S3). The vehicle VH may enter a turning course with the gear changed. The vehicle VH may enter the turning course after changing the gear. The control unit 5 may determine whether the vehicle VH enters the turning course (S4).

In case that the vehicle enters the turning course, a road on which the vehicle VH travels may have curvature, and the vehicle VH may enter the turning course while maintaining a constant speed. For example, a throttle of the vehicle VH may remain evenly open (even throttle).

The control unit 5 may control the rear wheels RR and RL such that the vehicle VH performs tuck-in in the turning course (S5). Tuck-in of the vehicle VH may refer to improving driving performance by concentrating load of the vehicle VH on the front wheels FR and FL during deceleration of the vehicle VH to sufficiently induce oversteer in the rear wheels RR and RL. Tuck-in of the vehicle VH may improve cornering performance of the vehicle VH. A method for tuck-in of the vehicle VH will be described below. In case that the vehicle VH exits the turning course through tuck-in, the vehicle VH may rapidly escape the turning course (full throttle). The control unit 5 may determine whether the vehicle VH exits the turning course (S6).

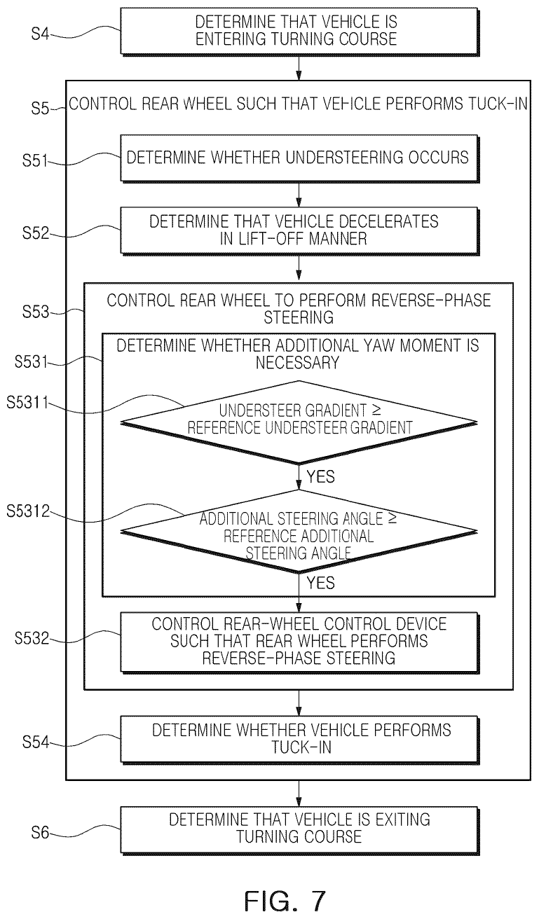

FIG. 7 is a schematic flowchart illustrating a portion of the vehicle control method S according to an embodiment.

Referring to FIGS. 3 and 7, the control unit 5 may control the rear wheels RR and RL such that the vehicle VH, having entered the turning course, may perform tuck-in to improve cornering performance (S5). In an embodiment, the controlling, by the control unit 5, the rear wheels RR and RL such that the vehicle VH performs tuck-in (S5) may include determining, by the control unit 5, whether understeering occurs in the vehicle VH (S51), determining, by the control unit 5, whether the vehicle decelerates in a lift-off manner (S52), and controlling, by the control unit 5, the rear wheels RR and RL to perform reverse-phase steering (S53). In an embodiment, the controlling, by the control unit 5, the rear wheels RR and RL such that the vehicle VH performs tuck-in (S5) may selectively include identifying, by the control unit 5, tuck-in of the vehicle VH (S54).

The control unit 5 may determine whether understeering occurs (S51). The yaw rate sensor 32 may measure a rotational angular velocity of the vehicle VH. The yaw rate sensor 32 may transmit data on a yaw rate of the vehicle VH to the control unit 5. In case that a yaw rate measured by the sensor unit 3 is less than a reference yaw rate stored in the control unit 5, the control unit 5 may determine that the vehicle VH has not rotated and thus understeering has occurred in the vehicle VH. The control unit 5 may determine whether understeering occurs in the vehicle VH by comparing the reference yaw rate with the yaw rate.

According to an embodiment, the control unit 5 may use the following Equation 1 to calculate the reference yaw rate. The control unit 5 may calculate and store the reference yaw rate, based on driving data of the vehicle VH received from the sensor unit 3.

$$\dot{Ψ} = \frac{{V}_{x} \cdot δ}{L + {K}_{u s} \cdot {V}_{x}^{2}} \qquad [ Equation 1 ]$$

Here, Ψ may be a reference yaw rate. L may be a wheelbase of the vehicle VH. Vₓ may be a vehicle speed. δ may be a steering angle. Kᵤₛ may be an understeer gradient. The vehicle speed (Vₓ) and the steering angle (δ) may be transmitted from the sensor unit 3 to the control unit 5. The understeer gradient (Kᵤₛ) may be a slope representing an increment amount of additional steering required due to lateral force in case that the vehicle VH turns, caused by understeering of the vehicle VH. The understeer gradient (Kᵤₛ) may represent a degree to which more steering needs to be applied as the speed of the vehicle VH increases in case that the vehicle VH turns. As the understeer gradient (Kᵤₛ) increases, understeering of the vehicle VH may become more severe, and a greater amount of steering input may be necessary. In case that the understeer gradient (Kᵤₛ) is about 0, the vehicle VH may be in a neutral steer state. As the understeer gradient (Kᵤₛ) decreases, the vehicle VH may become closer to neutral steer, and a steering response may increase. In case that the understeer gradient (Kᵤₛ) is a negative value, oversteer may occur in the vehicle VH. The understeer gradient (Kᵤₛ) may be determined by the wheelbase (L), suspension settings, tire characteristics, a method in which the vehicle VH is driven, and weight distribution of the vehicle VH. However, factors affecting the understeer gradient (Kᵤₛ) are not limited thereto. Alternatively, the control unit 5 may calculate, based on data obtained from the sensor unit 3, the understeer gradient (Kᵤₛ), and may use the following Equation 2.

$${K}_{us} = \frac{Δα}{{a}_{y}} = \frac{L}{R} \cdot \frac{R}{{V}_{ch}^{2}} = \frac{L}{{V}_{ch}^{2}} \qquad [ Equation 2 ]$$

Here, a_{y} may be lateral acceleration, R may be a rotation radius of the vehicle VH, V_{ch} may be a characteristic speed of the vehicle VH, and Δα may be an additional steering angle. The characteristic speed (V_{ch}) of the vehicle VH may refer to a speed at which the vehicle VH is at a boundary between understeer and neutral steer in case that the vehicle VH turns. In case that the vehicle VH travels at a speed lower than the characteristic speed (V_{ch}), the vehicle VH may be maintained in a neutral steer state. In case that the vehicle VH travels at a speed higher than the characteristic speed (V_{ch}), understeering may occur in the vehicle VH. As the speed of the vehicle VH increases, lateral force of a tire may exceed a limit thereof, resulting in the vehicle VH turning less than the steering input. Accordingly, a turning response of the vehicle VH may become dull (or not sharp), and the driver may need to provide an additional steering input to achieve desired rotation. The characteristic speed (V_{ch}) may vary depending on the wheelbase (L), the understeer gradient (Kᵤₛ), suspension settings, tire characteristics, and weight distribution of the vehicle VH, and vehicle factors affecting the characteristic speed (V_{ch}) are not limited thereto. The additional steering angle (Δα) may be a steering angle δ additionally input by the driver to move in a desired direction. The additional steering angle (Δα) may be calculated by the control unit 5 based on the following Equation 3.

$$Δ α = {α}_{f} - {α}_{r} = δ - \frac{L}{R} \qquad [ Equation 3 ]$$

Here, α_{f} may be a front wheel slip angle, and αᵣ may be a rear wheel slip angle. However, the control unit 5 may calculate an additional steering angle (Δα), based on data on the steering angle (δ), the wheelbase (L), and the rotation radius (R) of the vehicle VH.

Accordingly, the control unit 5 may calculate a reference yaw rate in real time, using data on the steering angle (δ), the acceleration, and the vehicle speed (Vₓ) obtained from the sensor unit 3, Equation 1, Equation 2, and Equation 3. In case that the reference yaw rate calculated in real time is greater than a yaw rate measured by the sensor unit 3, the control unit 5 may determine that understeering occurs in the vehicle VH. However, a method in which the control unit 5 calculates the reference yaw rate is not limited thereto.

In case that the control unit 5 determines that understeering occurs in the vehicle VH, the vehicle VH may decelerate in a lift-off manner. The control unit 5 may determine that the vehicle VH is decelerating in a lift-off manner (S52). Lift-off may refer to a situation in which, in case that a driver releases an accelerator pedal, behavior of the vehicle VH may change due to transfer of a load of the vehicle VH. In case that the vehicle VH is in a lift-off state, the load of the vehicle VH may transfer forward, grip force of the rear wheels RR and RL may decrease, and the possibility of oversteer may increase. In addition, in case that the vehicle VH is in a lift-off state, since the driver has released the accelerator pedal, the vehicle VH may decelerate due to rotational resistance of an engine (i.e., engine braking). In case that the vehicle VH is in a lift-off state, a throttle may be closed, an amount of air flowing into the engine may be limited, intake resistance may increase, and resistance may be generated inside the engine, which may cause a reduction in the speed of the vehicle VH.

In case that the rear wheels RR and RL perform reverse-phase steering, the control unit 5 may allow the rear wheels RR and RL to perform reverse-phase steering relative to the front wheels FL and FR (S53). Reverse-phase steering may refer to the rear wheels RR and RL steering in a direction opposite to that of the front wheels FR and FL. In case that the rear wheels RR and RL perform reverse-phase steering, steering performance of the vehicle VH may be improved, and driving stability may be increased. More specifically, in case that the rear wheels RR and RL perform reverse-phase steering, a rotation radius R of the vehicle VH may be reduced, and maneuverability of the vehicle VH may be increased. In the case of a vehicle VH having a long wheelbase (L), steering responsiveness may be improved through rear-wheel reverse-phase steering. According to an embodiment, in case that the vehicle VH turns right, the front wheels FR and FL may turn to the right. According to an embodiment, the allowing, by the control unit 5, the rear wheels RR and RL to perform reverse-phase steering (S53) may include determining, by the control unit 5, whether an additional yaw moment is necessary for the vehicle VH (S531), and controlling, by the control unit 5, the rear-wheel control device 7 such that the rear wheels RR and RL perform reverse-phase steering relative to the front wheels FR and FL (S532).

Even after understeering occurs in the vehicle VH and the vehicle enters a lift-off state as a result, the control unit 5 may determine whether an additional yaw moment is necessary for the vehicle VH (S531). In case that it is determined whether the vehicle VG requires an additional yaw moment (S531), the control unit 5 may determine whether an understeer gradient (Kᵤₛ) is greater than or equal to a reference understeer gradient (S5311). In case that the understeer gradient (Kᵤₛ) is greater than or equal to the reference understeer gradient stored in the control unit 5, the control unit 5 may determine that the vehicle VH does not rotate sufficiently. In case that the understeer gradient (Kᵤₛ) is greater than or equal to the reference understeer gradient stored in the control unit 5, the control unit 5 may compare an additional steering angle (Δα) with a reference additional steering angle stored in the control unit (S5312). In case that the additional steering angle Aa is greater than or equal to the reference additional steering angle, the control unit 5 may determine that the vehicle requires an additional yaw moment. That is, in case that the understeer gradient (Kᵤₛ) is greater than or equal to the reference understeer gradient, and the additional steering angle (Δα) is greater than or equal to the reference additional steering angle, the control unit 5 may determine that the vehicle VH does not rotate sufficiently and thus requires an additional yaw moment. For example, in case that the additional steering angle Aa, additionally input by the driver, is about 5° or more, the control unit 5 may determine that an additional yaw moment is necessary. The reference understeer gradient and the reference additional steering angle may be arbitrary setting values stored in the control unit 5.

In case that the control unit 5 controls the rear-wheel control device 7 such that the rear wheels RR and RL perform reverse-phase steering (S532), the rear wheels RR and RL may be reverse-phase controlled by the control unit 5 and the rear-wheel control device 7 to rotate to the left. In case that the vehicle VH turns left, the front wheels FR and FL may rotate to the left, and the rear wheels RR and RL may rotate to the right. The control unit 5 may reduce a grip burden on the front wheels FR and FL and reduce gripping of the rear wheels RR and RL by controlling the rear wheels RR and RL through the rear-wheel control device 7 to perform reverse-phase steering, thereby inducing oversteer of the vehicle VH. Reverse-phase control of the rear wheels RR and RL may reduce understeering of the vehicle VH and promote proper tuck-in, thereby increasing turning performance of the vehicle VH.

After the rear wheels RR and RL perform reverse-phase steering, the control unit 5 may determine whether the vehicle VH has performed tuck-in to increase turning performance of the vehicle VH (S54). The control unit 5 may monitor the understeer gradient (Kᵤₛ) and identify whether the understeer gradient (Kᵤₛ) has sufficiently decreased, thereby monitoring turning performance of the vehicle VH (S54). The control unit 5 may determine whether the vehicle VH has sufficiently performed tuck-in, in case that the understeer gradient (Kᵤₛ) is less than or equal to the reference understeer gradient.

According to the vehicle control system SY and the vehicle control method S based on the same according to an embodiment, straight-line braking stability of the vehicle VH may be increased. The control unit 5 may determine whether the vehicle VH is performing straight-line braking, using vehicle data obtained from the sensor unit 3. More specifically, the control unit 5 may determine whether straight-line braking is being performed by comparing the deceleration and the steering angle (δ) of the vehicle VH with a reference deceleration and a reference steering angle, respectively. In case that it is determined that the vehicle VH is performing straight-line braking, the control unit 5 may control the rear-wheel control device 7 such that rear wheels RR and RL are toed-in. In case that the rear wheels RR and RL are toed-in, a difference in lateral force between the left rear wheel RL and the right rear wheel RR may act as restoring force of the vehicle VH, thereby reducing a yaw moment of the vehicle VH and preventing the vehicle VH from experiencing severe slip.

According to the vehicle control system SY and the vehicle control method S based on the same according to an embodiment, turning performance of a vehicle VH may be increased. The control unit 5 may determine whether understeering occurs in the vehicle VH during turning, using vehicle data obtained from the sensor unit 3. More specifically, in case that a measured yaw rate is less than the reference yaw rate, the control unit 5 may determine that the vehicle VH has not sufficiently rotated and thus understeering has occurred in the vehicle VH. In addition, the control unit 5 may determine whether an additional yaw moment is necessary during turning of the vehicle VH, using the vehicle data. More specifically, in case that the understeer gradient (Kᵤₛ) is greater than or equal to the reference understeer gradient, and the additional steering angle (Δα) is greater than or equal to the reference additional steering angle, the control unit 5 may determine that an additional yaw moment is necessary for the vehicle VH. In case that it is determined that understeering has occurred in the vehicle VH and an additional yaw moment is necessary, the control unit 5 may control the rear-wheel control device 7 such that the rear wheels RR and RL perform reverse-phase steering relative to the front wheels FR, FL. Due to reverse-phase steering of the rear wheels RR and RL, a yaw moment may be generated, thereby improving turning performance of the vehicle VH. For example, in case that the rear wheels RR and RL perform reverse-phase steering relative to the front wheels FR, FL by about 2° or more, a yaw moment that increases turning responsiveness of the vehicle VH may be generated.

While embodiments have been shown and described above, it will be apparent to those skilled in the art that modifications and variations could be made without departing from the scope of the present disclosure as defined by the appended claims.

What is claimed is:

1. A vehicle control system comprising:
a steering unit configured to control a direction of a vehicle;
a sensor unit configured to detect driving data of the vehicle;
a rear-wheel control device configured to control each of a plurality of rear wheels independently; and
a control unit electrically connected to the steering unit, the sensor unit, and the rear-wheel control device and configured to control, based on a detection value of the sensor unit, an angle of each rear wheel independently of a front wheel of the vehicle by the rear-wheel control device.

2. The vehicle control system of claim 1, wherein the sensor unit includes:
an acceleration sensor configured to detect an acceleration of the vehicle; and
a steering sensor configured to detect a steering angle and a steering speed of the front wheel of the vehicle.

3. The vehicle control system of claim 2, wherein the control unit is configured to control the rear-wheel control device, based on deceleration of the vehicle detected by the acceleration sensor and the steering angle and the steering speed of the front wheel of the vehicle detected by the steering sensor, such that the rear wheel is toed-in.

4. The vehicle control system of claim 1, wherein:
the angle includes a toe-in angle of the rear wheel, and
the toe-in angle is in a range of about 0 degrees to about 2 degrees.

5. The vehicle control system of claim 1, wherein:
the control unit is configured to control the rear-wheel control device such that the rear wheel of the vehicle is toed-in, and
the control unit is configured to determine, based on a yaw rate change rate of the vehicle measured by the sensor unit, straight-line braking stability of the vehicle.

6. The vehicle control system of claim 1, wherein the driving data of the vehicle includes a speed, a steering angle, a steering speed, and an understeer gradient of the vehicle.

7. The vehicle control system of claim 6, wherein the control unit is configured to determine whether understeering occurs by comparing a reference yaw rate, based on the driving data of the vehicle, with a yaw rate of the vehicle obtained from the sensor unit.

8. The vehicle control system of claim 1, wherein:
the control unit is configured to determine whether understeering occurs in the vehicle, based on the driving data of the vehicle, and
the control unit is configured to determine whether an additional yaw moment is necessary for the vehicle, based on an understeer gradient and an additional steering angle obtained by the sensor unit, and to control the rear wheel through the rear-wheel control device.

9. The vehicle control system of claim 8, wherein the control unit is configured to control the rear-wheel control device such that the rear wheel performs reverse-phase steering relative to the front wheel of the vehicle.

10. A vehicle control method comprising:
determining, by a control unit, whether a vehicle approaches to a turning course;
controlling, by the control unit, a rear wheel based on deceleration of the vehicle; and
determining, by the control unit, whether the vehicle changes a gear,
wherein controlling the rear wheel includes: controlling an angle of the rear wheel, based on a deceleration and a steering angle and a steering speed of the vehicle detected by the sensor unit.

11. The vehicle control method of claim 10, wherein controlling the rear wheel includes: controlling toe of the rear wheel in case that the deceleration measured by the sensor unit is greater than or equal to a reference deceleration and the steering angle and the steering speed is less than or equal to a reference steering angle.

12. The vehicle control method of claim 11, further comprising: storing, in the control unit, data on the reference deceleration and the reference steering angle.

13. The vehicle control method of claim 11, wherein:
the control unit is configured to control the rear-wheel control device such that the rear wheel is toed-in, and
an angle at which the rear wheel is toed-in is in a range of about 0 degrees to about 2 degrees.

14. The vehicle control method of claim 10, further comprising:
determining, by the control unit, whether the vehicle enters a turning course;
controlling, by the control unit, the rear wheel such that the vehicle performs tuck-in;
determining, by the control unit, whether the vehicle exits the turning course; and
wherein controlling the rear wheel includes controlling the rear wheel using an understeer gradient and an additional steering angle.

15. The vehicle control method of claim 14, wherein controlling the rear wheel includes: controlling, by the control unit, the rear wheel to perform reverse-phase steering relative to the front wheel, in case that the understeer gradient is greater than or equal to a reference understeer gradient and the additional steering angle is greater than or equal to a reference additional steering angle.

16. A vehicle control method comprising:
determining, by a control unit, whether a vehicle approaches a turning course;
controlling, by the control unit, a rear wheel in case that the vehicle decelerates;
determining, by the control unit, whether the vehicle changes a gear;
determining, by the control unit, whether the vehicle enters the turning course;
controlling, by the control unit, the rear wheel based on deceleration of the vehicle such that the vehicle performs tuck-in; and
determining, by the control unit, whether the vehicle exits the turning course,
wherein controlling the rear wheel includes controlling a rear-wheel control device such that the rear wheel is toed-in based on a steering angle of the vehicle.

17. The vehicle control method of claim 16, wherein
in case that the vehicle decelerates, the control unit is configured to control the rear-wheel control device such that the rear wheel are toed-in in case that the steering angle of the vehicle is less than or equal to a reference steering angle, and
a toe-in angle of the rear wheel is in a range of about 0 degrees to about 2 degrees.

18. The vehicle control method of claim 16, wherein controlling the rear wheel such that the vehicle performs tuck-in includes:
determining, by the control unit, whether understeering occurs in the vehicle;
determining, by the control unit, whether the vehicle decelerates in a lift-off manner; and
controlling, by the control unit, the rear-wheel control device such that the rear wheel performs reverse-phase steering relative to the front wheel.

19. The vehicle control method of claim 18, wherein controlling the rear-wheel control device such that the rear wheel performs reverse-phase steering relative to the front wheel is performed in case that an understeer gradient of the vehicle is greater than or equal to a reference understeer gradient, and an additional steering angle of the vehicle is greater than or equal to a reference additional steering angle.

20. The vehicle control method of claim 16, wherein
the rear-wheel control device includes a first rear-wheel control device and a second rear-wheel control device, and
the first rear-wheel control device and the second rear-wheel control device independently control a left rear wheel and a right rear wheel, respectively.
